(19) United States
(12) Patent Application Publication
(10) Pub. No.: US 2007/0214198 A1
(43) Pub. Date: Sep. 13, 2007

(54) Allowing state restoration using differential backing objects

(76) Inventors: Nathan Fontenot, Cedar Park, TX (US); Joel H. Schopp, Austin, TX (US); Michael Thomas Strosaker, Round Rock, TX (US); Brad Thomas Peters, Beaverton, OR (US)

Correspondence Address: KONRAD RAYNES & VICTOR, LLP.;ATTN: IBM37, 315 SOUTH BEVERLY DRIVE, SUITE 210, BEVERLY HILLS, CA, 90212, US

(21) Appl. No.: 11/373,774

(22) Filed: Mar. 10, 2006

(51) Int. Cl. G06F 17/30

(52) U.S. Cl. 707/204

(57) ABSTRACT

Provided are a method, system, and article of manufacture for allowing state restoration using differential backing objects. A base image comprising operating system files, configuration files, and device driver files installed on a plurality of clients is accessed. Differential backing objects for the clients are generated indicating differences between local images on the clients following installation of the base image. Applying one of the differential backing objects to the base image forms one of the local images at one of the clients at a point-in-time of when the differential backing object was created. The differential backing objects from the clients are stored in the storage.

### BACKGROUND OF THE INVENTION

1. Field of the Invention

The present invention relates to a method, system, and program for allowing state restoration using differential backing objects.

2. Description of the Related Art

At some point, a system may need to be restored to a previous or subsequent state. One solution is to remove (e.g., wipe) the current installation and perform a full install of all the files for a state from an image created from the state to restore. In certain environments that require frequent restoration to a state, such as systems used for testing software, significant delays can be experienced to continually restore a system to a state using the full installation method. Further, if the state or image to which the system installation is returned must be transferred over the network, installation to a state may require transfer of a substantial amount of data, e.g., several gigabytes, over a network, which may further delay the restoration process and overload the network causing network delays. This problem is also experienced in enterprise environments where a common base installation is made to all the systems and to restore the base installation on one of the systems, the entire base image must be transferred over the network to the client.

For these reasons, there is a need in the art for improved techniques for maintaining system states and restoring a system to a previous or subsequent state.

### SUMMARY

Provided are a method, system, and article of manufacture for allowing state restoration using differential backing objects. A base image comprising operating system files, configuration files, and device driver files installed on a plurality of clients is accessed. Differential backing objects for the clients are generated indicating differences between local images on the clients following installation of the base image. Applying one of the differential backing objects to the base image forms one of the local images at one of the clients at a point-in-time of when the differential backing object was created. The differential backing objects from the clients are stored in the storage.

In a further embodiment, files in a local image on the system and a base image of files initially installed on the system are accessed. The files in the local image are compared with the base image of files. For each file in the local image comprising a modified version of the file in the base image, a determination is made of the differences between the modified version of the file and the base image. The determined differences are stored in a differential backing object in the storage.

### BRIEF DESCRIPTION OF THE DRAWINGS

FIG. 1 illustrates an embodiment of a network computing environment.

FIG. 2 illustrates an embodiment of differential backing object metadata.

FIG. 3 illustrates an embodiment of a differential backing object.

FIG. 4 illustrates an embodiment of operations to create a differential backing object.

FIG. 5 illustrates an embodiment to restore a system state from a differential backing object.

FIG. 6 illustrates an alternative embodiment of a computing environment.

FIG. 7 illustrates an embodiment of a computer architecture that may be used with the systems in FIGS. 1 and 6.

### DETAILED DESCRIPTION

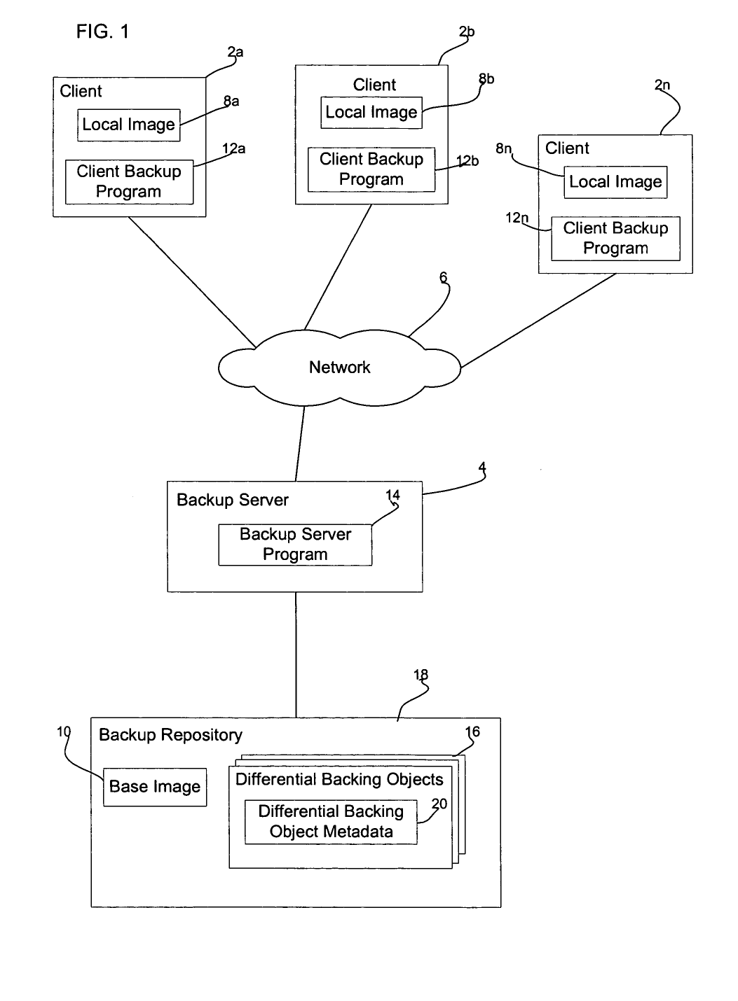

FIG. 1 illustrates an embodiment of a network computing environment. Clients 2a, 2b . . . 2n communicate with a backup server 4 over a network 6. Each client 2a, 2b . . . 2n includes a local image 8a, 8b . . . 8n comprising operating system files, configuration files, device drivers, application programs, etc. In one embodiment, the clients 2a, 2b . . . 2n may be part of an environment where a common base image 10 is installed in each client 2a, 2b . . . 2n. Over time, the clients 2a, 2b . . . 2n may modify the files in the initially installed base image 10 resulting in local images 8a, 8b . . . 8n on each client that may differ.

Each client 2a, 2b . . . 2n includes a backup client program 12a, 12b . . . 12n that communicates backup related requests to a backup server program 14. A backup client program 12a, 12b . . . 12n may initiate an operation to create a differential backing object, such as one of the differential objects 16, that indicates differences between the current local image 8a, 8b . . . 8n at the client 2a, 2b . . . 2n and the base image 10. The backup server program 14 is coupled to a backup repository 18 that stores the base image 10 and the differential backing objects 16 created from the client local images 8a, 8b . . . 8n. The backup repository 18 may include multiple differential backing objects 16 for each of the clients 2a, 2b . . . 2n indicating different states of the local image 8a, 8b . . . 8n at different times. In certain embodiments, the backing objects 16 may not indicate changes made by the client backup programs 12a, 12b . . . 12n. The backup server program 14 may maintain differential backing object metadata 20 for each differential backing object 16 having information on the differential backing objects 16. (Differential backing object 16 refers to one or more instances of a differential backing object). The backing object metadata 20 is shown as included in a differential backing object 16. In an alternative embodiment, the metadata 20 may be stored separately from the backing objects 16. The client backup programs 12a, 12b . . . 12n may interact with the backup server program 14 to restore the client 2a, 2b . . . 2n image to a state recorded in one of the differential backing objects 16 for the client 2a, 2b . . . 2n in the backup repository 18.

The clients 2a, 2b . . . 2n that communicate with the backup server 4 may comprise suitable computational devices known in the art, such as servers, desktop computers, workstations, mainframes, hand held computing devices, telephony devices, etc. The backup repository 18 may be implemented in a storage system known in the art, such as a storage system including a plurality of storage devices, e.g., interconnected hard disk drives (a Redundant Array of Independent Disks (RAID), Just a Bunch of Disks (JBOD), Direct Access Storage Device (DASD), disks connected in a loop configuration (serial loop, Fibre Channel Arbitrated Loop), a single storage device, a tape library, an optical library, a network attached storage (NAS), etc. The network 6 may comprise a Wide Area Network (WAN), Local Area Network (LAN), Storage Area Network (SAN), wireless network, the Internet, an Intranet, peer-to-peer network, etc.

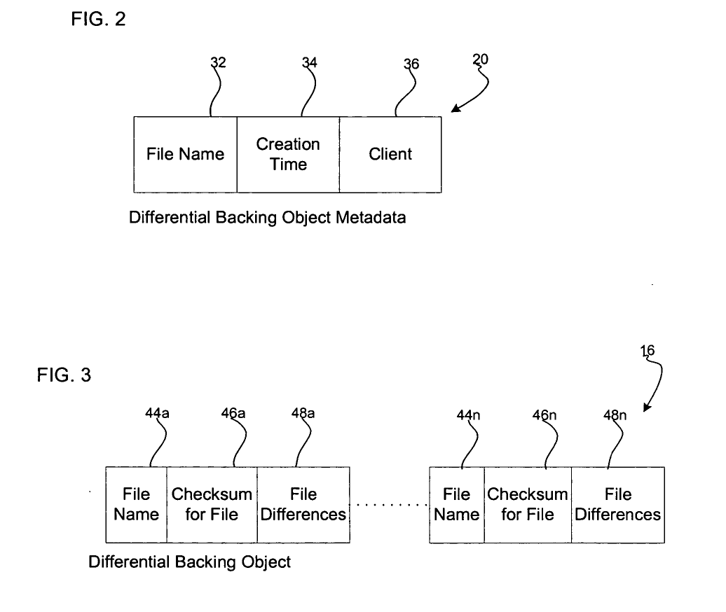

FIG. 2 illustrates an embodiment of an instance of the differential backing object metadata 20 as including: a file name 32 identifying a differential backing object 16 in the backup repository 18; a creation time 34 indicating the time at which the differential backing object 16 was created; and a client 36 comprising the client 2a, 2b . . . 2n whose local image 8a, 8b . . . 8n at the creation time 34 is represented and recorded in the identified differential backing object 16. Differential backing object metadata 20 may refer to one or more instances of the metadata.

In one embodiment, the differential backing object metadata 20 may be maintained in a database, such as a relational database, or included in one or more files separate from the file(s) including differential backing objects 16. In an additional embodiment, the metadata 20 for one differential backing object 16 may be encoded in a file name of the differential backing object 16 and visible in a user interface displaying file names. Alternatively, the metadata 20 may be included in accessible fields of the differential backing object 16.

FIG. 3 illustrates an embodiment of a differential backing object 16 as including for each file in the local image 8a, 8b . . . 8n from which the differential backing object 16 was created: a file name 44a . . . 44n of the file in the local image 8a, 8b . . . 8n (where there are n files); a checksum 46a . . . 46n calculated from the file; and file differences 48a . . . 48n indicating each bit of the file in the local image 8a, 8b . . . 8n at the creation time 34 of the differential backing object 16 that differs from the corresponding bit in the base image 10. Merging the differences 48a . . . 48n with the copy of the file in the base image 10 forms the version of the file in the local image 8a, 8b . . . 8n at the creation time 34 of the differential backing object 16. If the file 44a . . . 44n in the local image 8a, 8b . . . 8n was added anytime after the installation of the base image 10 at the client 2a, 2b . . . 2n, then the differences 48a . . . 48n for the added file may comprise the entire file in the current local image 8a, 8b . . . 8n. The differential backing object 16 may include additional metadata, such as metadata on the files 44a . . . 44n and the file differences 48a . . . 48n.

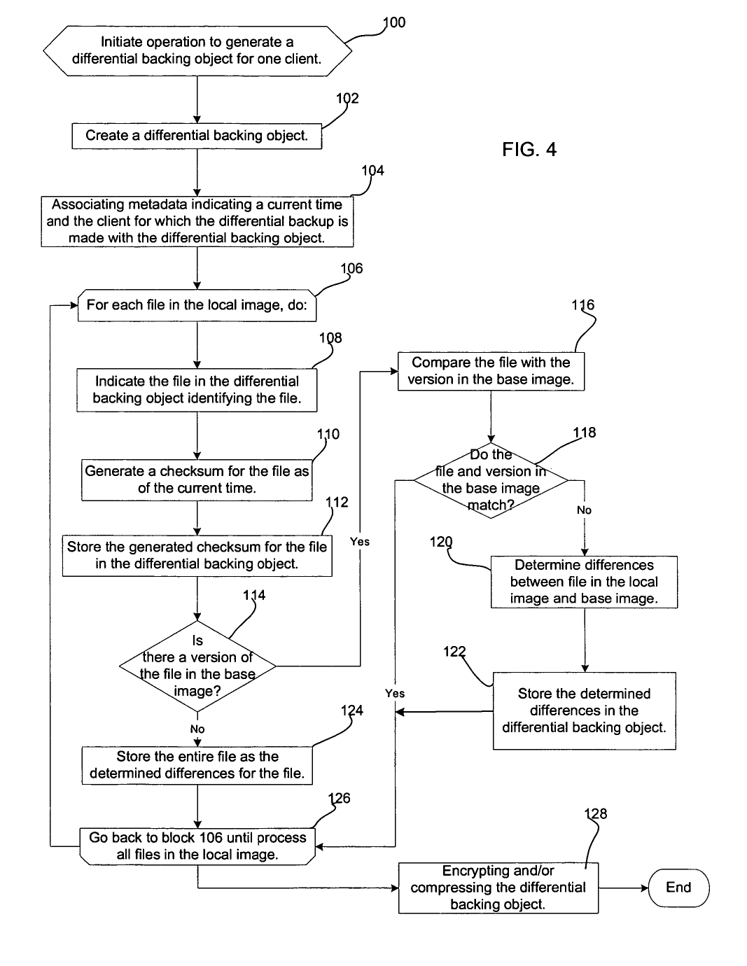

FIG. 4 illustrates an embodiment of operations performed by the backup server program 14 to generate a differential backing object 16 based on the local image 8a, 8b . . . 8n at one client 2a, 2b . . . 2n. The client backup program 12a, 12b . . . 12n may initiate a request to the backup server program 14 to create a differential backing object 16. Upon initiating (at block 100) the operation to create a differential backing object 16, the backup server program 14 creates (at block 102) a differential backing object 16. Metadata 20 (FIG. 2) indicating a current time as the creation time 34 and the client 36 for which the differential backing object is being made is generated and associated (at block 104) with the differential backing object 16 being created.

The backup server program 14 may then scan the local image 8a, 8b . . . 8n of the client 2a, 2b . . . 2n initiating the request and perform the operations at blocks 106 through 126 for each file in the local image 8a, 8b . . . 8n. While the differential backing object 16 is being created, the client backup program 12a, 12b . . . 12n may buffer changes to the local image 8a, 8b . . . 8n so that the differential backing object 16 represents the local image 8a, 8b . . . 8n as of the creation time 34. The buffer changes may be applied to the local image 8a, 8b . . . 8n after completion of the differential backing object 16. For each file in the local image 8a, 8b . . . 8n, the backup server program 14 indicates (at block 108) the file name 44a . . . 44n in the differential backing object identifying the current file in the local image 8a, 8b . . . 8n being considered. The backup server program 14 generates (at block 110) a checksum 46a . . . 46n for the file as of the creation time 34 of the differential backing object 16 and stores (at block 112) the generated checksum in the differential backing object 16.

If (at block 114) there is a version of the file in the base image 10, then the file in the local image 8a, 8b . . . 8n is compared (at block 116) with the version of the file in the base image 10. If (at block 118) the compared files do not match, i.e., the file has changed since the base image 10 was installed, then the backup server program 14 determines (at block 120) the differences 48a . . . 48n between the file in the local image 8a, 8b . . . 8n and the base image 10 and stores (at block 122) the determined differences 48a . . . 48n in the differential backing object 16. If the files do match (at the yes branch of block 118), i.e., there has been no change since the installation of the base image 10, or after storing the differences 48a . . . 48n (at block 122), then control proceeds (at block 126) back to block 106 if there are further files in the local image 8a, 8b . . . 8n to consider. After processing all files in the local image 8a, 8b . . . 8n, control proceeds to block 128 where the backup sever program 14 may encrypt and/or compress the generated differential backing object 16 and store the generated differential backing object 16 in the backup repository 18. As discussed, the backup repository 18 may maintain multiple differential backing objects 16 for the clients 2a, 2b . . . 2n. In an additional embodiment, the backup server program 14 may determine a checksum for the entire file and then just that checksum value is encrypted and stored at the end of the differential backing object 20.

In one embodiment, the operations of FIG. 4 may be performed by the backup server program 14. In an alternative embodiment, the client backup program 12a may perform the operations to generate the differential backing object 16 by scanning the base image 10 to compare with the files in the local image 8a, 8b . . . 8n, and then transfer the differential backing object 16 to the backup server program 14 to store in the backup repository 18.

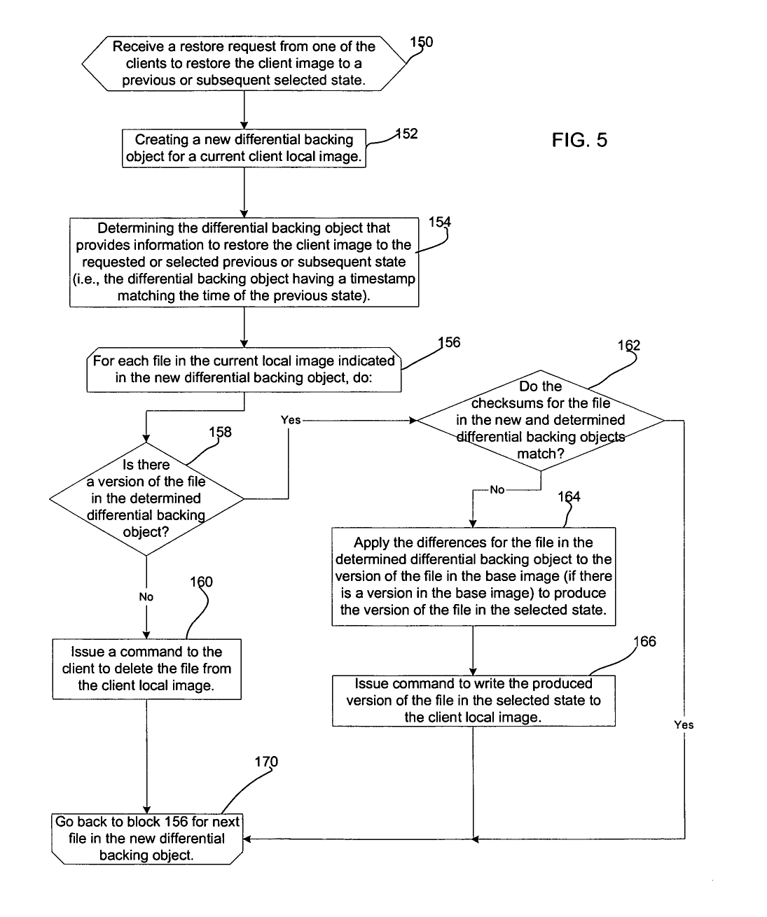

FIG. 5 illustrates an embodiment of operations performed by the backup server program 14 to restore a local image 8a, 8b . . . 8n from a differential backing object 16 to the state at the creation time 34 (FIG. 2) of the differential backing object 16. In response to receiving (at block 150) a restore request from one of the clients 2a, 2b . . . 2n to restore the client image to a previous or subsequent selected state, the backup server program 14 creates (at block 152) a new differential backing object 16 for the current client local image 8a, 8b . . . 8n by performing the operations of FIG. 4. The restore request may comprise a request to return to a subsequent selected state if a restore was previously performed to return to a prior state and the current restore request is to return to a subsequent state. For instance, an initial restore request may be performed with respect to a differential backing object at a first creation time and a later restore request is initiated to restore the image using a differential backing object having a creation time later than the first creation time. This restore request to a later time comprises a subsequent restore request. The operation at block 152 may be optionally performed to create a backing object 16 for the current state before the system is restored to another state (prior or subsequent) represented by a backing object. Further, the operation at block 152 may have been performed prior to the request for state restoration, as opposed to being performed as part of the restore request as shown in FIG. 5. The backup server program 14 determines (at block 154) the differential backing object 16 that represents and records the state to which a user wants to restore the client system, i.e., a selected previous or subsequent state. The determined differential backing object 16 may comprise the differential backing object whose creation time 34 is the time of the selected previous or subsequent state. In one embodiment, a user at the client may use the client backup program 12 to gather and present information on the creation times 34 of the differential backing objects 16 for the client and then, through the client backup program 12, select a state identified by the creation time of one of the differential backing objects 16 for the client 2a, 2b . . . 2n. The state may be identified by alternative information, such as user labels of the differential backing object 20, the size of the differential backing object 20, the size of the object 20 (which provides a measure of the amount of change since creation of the base, full backup image), or other information. The determined differential backing object 16 comprises the differential backing object providing the (previous or subsequent) state of the system that the user at the client 2a, 2b . . . 2n wants to restore.

The backup server program 14 then performs the operations at blocks 156 to 170 for each file 44a . . . 44n identified in the new created backup differential object representing the state of the local image 8a, 8b . . . 8n when the restore request was made. If (at block 158) there is not a version of the file in the current image in the determined differential backing object 16, then a command is issued (at block 160) to delete the file in the current local image 8a, 8b . . . 8n because the file was added after the determined differential backing object was created, i.e., after the selected state to restore. In an alternative embodiment, if there is not a version of the file, then a delete may be specified, but the deletion of the file does not have to be automatic. If (at block 158) there is a version of the file in the determined differential backing object 16 for the state to restore, then the backup server program 14 compares (at block 162) the checksums for the file in the new backup differential object representing the current state of the local image 8a, 8b . . . 8n and the checksum in the determined differential backing object 16 for the file. If (at block 162) the checksums do not match, then the file has changed since the state represented in the determined differential backing object 16 and the backup server program 14 applies (at block 164) the differences 48a . . . 48 for the file in the determined differential backing object to the version of the file in the base image (if there is a version in the base image) to produce the version of the file in the selected state. As mentioned, if there is not a version in the base image, then control proceeds to block 160. A command is issued (at block 166) to write the reproduced version of the file in the selected state to the client local image 8a. 8b . . . 8n. If (at block 162) the checksums match, then control proceeds to block 170 because the file has not changed since the selected state and no further action is needed with respect to the unchanged file. From block 160, 168 or the yes branch of block 162, control proceeds (at block 170) back to block 156 to consider a next file indicated in the new differential backing object. After considering each file in the current local image indicated in the new differential backing object in the loop from blocks 156 to 170, control would end.

The embodiment of FIG. 5 may conserve network 6 (see FIG. 1) bandwidth because only the files that have changed are communicated over the network 6 to the client 2a, 2b . . . 2n to apply to the local image 8a, 8b . . . 8n to replace a file that has been modified since the selected state and delete commands are communicated to delete files added after the selected state. In this way, the selected state is restored by transferring only those files and commands necessary to restore the local image to the selected state represented in the determined differential backing object.

In one embodiment, the operations of FIG. 5 may be performed by the backup server program 14. In an alternative embodiment, the client backup program 12a, 12b . . . 12n may perform the operations to restore the state from a determined differential backing object 16 by comparing files in the local image 8a, 8b . . . 8n with files indicated in the determined differential backing object 16.

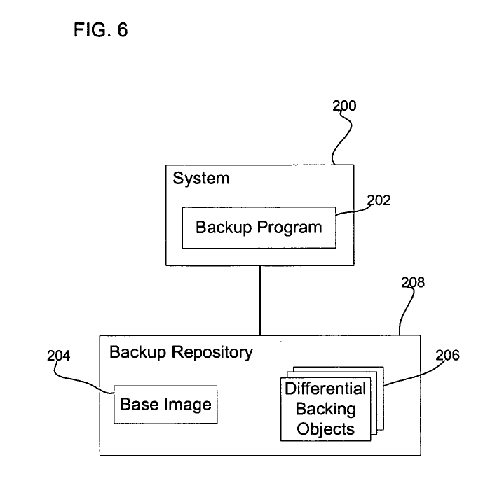

FIG. 6 illustrates an alternative embodiment of how the backup operations described herein may be deployed with a standalone system. A computer system 200 includes a backup program 202 that can access a base image 204 of the initial installation on the computer system 200 and differential backing objects 206 in a backup repository 208. The backup repository 208 may be implemented in a local hard disk drive of the computer system 200 or in a network or external storage. In the embodiment of FIG. 6, the backup program 202 may perform the operations of FIGS. 4 and 5, excluding the network related operations, to create differential backing objects 206 and restore the system 200 state to a state represented in a differential backing object 206.

Described embodiments provide techniques to use to maintain a base and differential backing objects for multiple system environments where each system is provided with the same initial base installation, and where each system may develop over time different system states that may be recorded and stored in differential backing objects. For instance, the environment may comprise a testing environment where the clients 2a, 2b . . . 2n comprise testing stations provided with the same initial base image 10. Software developers may test programs on the client systems and record the clients' current states in differential backing objects before testing. A previous system state may be restored in one or more clients using the differential backing objects representing and recording the state before initiating testing to ensure that testing is performed with respect to a known or selected state.

Additionally, the described embodiments may be used in an enterprise or standalone environment to allow a system to recover to a last known good state in event that the current state becomes corrupted. The differential backing objects may be encrypted to prevent unauthorized access and to protect the system state recorded in the differential backing object that has changed since the common base state was installed across the network.

Further, with described embodiments, the clients 2a, 2b . . . 2n or system 200 may be restored to any state. If the differential backing objects for a client represent a series of consecutive states, then the client may be restored to any state, including a state that is non-sequential with respect to the current state by selecting the differential backing object representing the desired state. For instance, if a client has differential backing objects representing and recording states A, B, C, D and the client is currently in state D, then the client can be restored to any previous state, e.g., A, B, C. If the client is at a previous state, e.g., A, then the system can be restored to any of the subsequent states, e.g., B, C, D, in or out of sequence.

### Additional Embodiment Details

The described operations may be implemented as a method, apparatus or article of manufacture using standard programming and/or engineering techniques to produce software, firmware, hardware, or any combination thereof. The described operations may be implemented as code maintained in a “computer readable medium”, where a processor may read and execute the code from the computer readable medium. A computer readable medium may comprise media such as magnetic storage medium (e.g., hard disk drives, floppy disks, tape, etc.), optical storage (CD-ROMs, DVDs, optical disks, etc.), volatile and non-volatile memory devices (e.g., EEPROMs, ROMs, PROMs, RAMs, DRAMs, SRAMs, Flash Memory, firmware, programmable logic, etc.), etc. The code implementing the described operations may further be implemented in hardware logic (e.g., an integrated circuit chip, Programmable Gate Array (PGA), Application Specific Integrated Circuit (ASIC), etc.). Still further, the code implementing the described operations may be implemented in “transmission signals”, where transmission signals may propagate through space or through a transmission media, such as an optical fiber, copper wire, etc. The transmission signals in which the code or logic is encoded may further comprise a wireless signal, satellite transmission, radio waves, infrared signals, Bluetooth, etc. The transmission signals in which the code or logic is encoded is capable of being transmitted by a transmitting station and received by a receiving station, where the code or logic encoded in the transmission signal may be decoded and stored in hardware or a computer readable medium at the receiving and transmitting stations or devices. An “article of manufacture” comprises computer readable medium, hardware logic, and/or transmission signals in which code may be implemented. A device in which the code implementing the described embodiments of operations is encoded may comprise a computer readable medium or hardware logic. Of course, those skilled in the art will recognize that many modifications may be made to this configuration without departing from the scope of the present invention, and that the article of manufacture may comprise suitable information bearing medium known in the art.

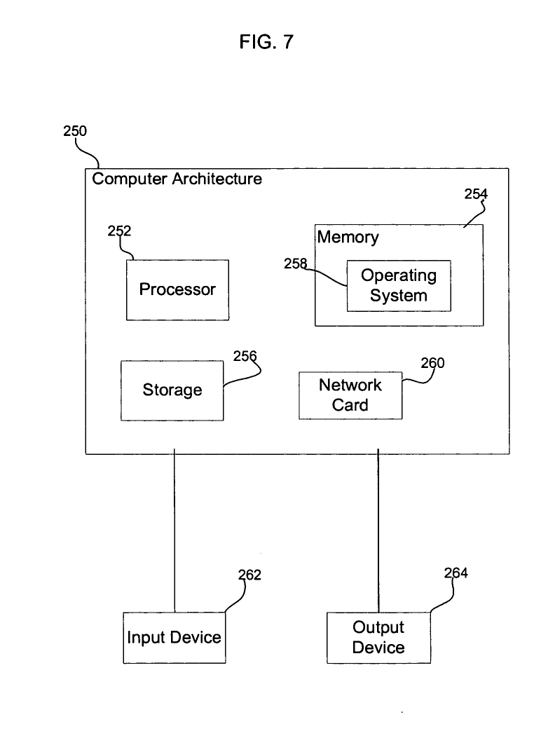

FIG. 7 illustrates one implementation of a computer architecture 250 that may be implemented at the clients 2a, 2b . . . 2n (FIG. 1), the backup server 4, and the system 200 (FIG. 6). The architecture 250 may include a processor 252 (e.g., a microprocessor), a memory 254 (e.g., a volatile memory device), and storage 256 (e.g., a non-volatile storage, such as magnetic disk drives, optical disk drives, a tape drive, etc.). The storage 256 may comprise an internal storage device or an attached or network accessible storage. Programs, including an operating system 258, device drivers and application programs, in the storage 256 are loaded into the memory 254 and executed by the processor 252 in a manner known in the art. The architecture further includes a network card 260 to enable communication with a network. An input device 262 is used to provide user input to the processor 262, and may include a keyboard, mouse, pen-stylus, microphone, touch sensitive display screen, or any other activation or input mechanism known in the art. An output device 264 is capable of rendering information transmitted from the processor 252, or other component, such as a display monitor, printer, storage, etc.

The terms “an embodiment”, “embodiment”, “embodiments”, “the embodiment”, “the embodiments”, “one or more embodiments”, “some embodiments”, and “one embodiment” mean “one or more (but not all) embodiments of the present invention(s)” unless expressly specified otherwise.

The terms “including”, “comprising”, “having” and variations thereof mean “including but not limited to”, unless expressly specified otherwise.

The enumerated listing of items does not imply that any or all of the items are mutually exclusive, unless expressly specified otherwise.

The terms “a”, “an” and “the” mean “one or more”, unless expressly specified otherwise.

The variable “n” when used to represent a variable number of an element may indicate any number of instances of the element, and may indicate different integer numbers when used with different elements.

Devices that are in communication with each other need not be in continuous communication with each other, unless expressly specified otherwise. In addition, devices that are in communication with each other may communicate directly or indirectly through one or more intermediaries.

A description of an embodiment with several components in communication with each other does not imply that all such components are required. On the contrary a variety of optional components are described to illustrate the wide variety of possible embodiments of the present invention.

Further, although process steps, method steps, algorithms or the like may be described in a sequential order, such processes, methods and algorithms may be configured to work in alternate orders. In other words, any sequence or order of steps that may be described does not necessarily indicate a requirement that the steps be performed in that order. The steps of processes described herein may be performed in any order practical. Further, some steps may be performed simultaneously.

When a single device or article is described herein, it will be readily apparent that more than one device/article (whether or not they cooperate) may be used in place of a single device/article. Similarly, where more than one device or article is described herein (whether or not they cooperate), it will be readily apparent that a single device/article may be used in place of the more than one device or article or a different number of devices/articles may be used instead of the shown number of devices or programs. The functionality and/or the features of a device may be alternatively embodied by one or more other devices which are not explicitly described as having such functionality/features. Thus, other embodiments of the present invention need not include the device itself.

The differential backing object shown in FIG. 3 may be implemented as a single object or file or as multiple files or objects.

The illustrated operations of FIGS. 4 and 5 show certain events occurring in a certain order. In alternative embodiments, certain operations may be performed in a different order, modified or removed. Moreover, steps may be added to the above described logic and still conform to the described embodiments. Further, operations described herein may occur sequentially or certain operations may be processed in parallel. Yet further, operations may be performed by a single processing unit or by distributed processing units.

The foregoing description of various embodiments of the invention has been presented for the purposes of illustration and description. It is not intended to be exhaustive or to limit the invention to the precise form disclosed. Many modifications and variations are possible in light of the above teaching. It is intended that the scope of the invention be limited not by this detailed description, but rather by the claims appended hereto. The above specification, examples and data provide a complete description of the manufacture and use of the composition of the invention. Since many embodiments of the invention can be made without departing from the spirit and scope of the invention, the invention resides in the claims hereinafter appended.

What is claimed is:

1. An article of manufacture including code enabled to cause communication with a plurality of clients and a storage, wherein the code is enabled to cause operations to be performed, the operations comprising:
accessing a base image comprising operating system files, configuration files, and device driver files installed on the clients;
generating differential backing objects for the clients indicating differences between local images on the clients following installation of the base image, wherein applying one of the differential backing objects to the base image forms one of the local images at one of the clients at a point-in-time of when the differential backing object was created; and
storing the differential backing objects from the clients in the storage.

2. The article of manufacture of claim 1, wherein the operations further comprise:
generating a timestamp of the point-in-time when each differential backing object was created to associate in metadata for the differential backing object; and
encrypting each differential backing object.

3. The article of manufacture of claim 1, wherein generating the differential backing objects for the local images on the clients further comprises:
comparing each file in the local image with each file in the base image to determine differences; and
storing the determined differences in the differential backing object resulting in an entire file in the local image being stored in the differential backing object if there is no version of the file in the base image.

4. The article of manufacture of claim 1, wherein generating the differential backing objects further comprises:
generating a checksum for each file in the local image;
storing each generated checksum in the differential backing object.

5. The article of manufacture of claim 1, wherein the operations further comprise:
receiving a restore request from one of the clients to restore the local image of the client to a selected state indicated in one of the differential backing objects;
determining the differential backing object representing the selected state of the requesting client;
determining each file in the current local image that comprises a modified version of one file indicated in the determined differential backing object; and
for each determined file in the current local image, applying differences for the file in the determined differential backing object to a version of the file in the base image to generate the file as of the selected state; and
writing the generated file as of the selected state to the client.

6. The article of manufacture of claim 5, wherein the operations further comprise:
generating in each differential backing object a checksum for each file in the local image; and
storing the generated checksums in the differential backing object, wherein determining each file in the current local image that comprises the modified version comprises:
calculating a checksum of the file in the current local image; and
comparing the calculated checksum with the checksum for the file in the determined differential backing object, wherein the current local image includes the modified version of the file if the compared checksums differ.

7. The article of manufacture of claim 5, wherein the operations further comprise:
determining each file in the current local image added since the selected state; and
deleting each determined file added since the selected state.

8. The article of manufacture of claim 5, wherein the restore request is communicated from the client system to a server over a network, and wherein the server performs the operations of determining the differential backing object, determining each file in the current local image that comprises the modified version, applying the differences to generate the file as of the selected state, and writing the generated file, wherein the server communicates the generated file to the client over the network.

9. The article of manufacture of claim 5, wherein the operations further comprise:
generating a differential backing object for the current local image indicating differences between files in the current local image and the base image, wherein determining each file in the current local image that comprises the modified version comprises comparing indication of the file in the generated differential backing object for the current local image and indication of the file in the determined differential backing object for the selected state.

10. The article of manufacture of claim 1, wherein the operations further comprise:
generating in each differential backing object a checksum for each file in the local image; and
storing the generated checksums in the differential backing object.

11. An article of manufacture including code enabled to cause communication with a system and a storage, wherein the code is enabled to cause operations to be performed, the operations comprising:
accessing files in a local image on the system and a base image of files initially installed on the system;
comparing files in the local image with the base image of files;
for each file in the local image comprising a modified version of the file in the base image, determining differences between the modified version of the file and the base image; and
storing the determined differences in a differential backing object in the storage.

12. The article of manufacture of claim 11, wherein the operations further comprise:
calculating a checksum for each file in the local image; and
storing the calculated checksums in the differential backing object.

13. A method, comprising:
maintaining a base image comprising operating system files, configuration files, and device driver files installed on a plurality of clients;
generating differential backing objects for the clients indicating differences between local images on the clients following installation of the base image, wherein applying one of the differential backing objects to the base image forms one of the local images at one of the clients at a point-in-time of when the differential backing object was created; and
storing the differential backing objects from the clients.

14. The method of claim 13, wherein generating the differential backing objects for the local images on the clients further comprises:
comparing each file in the local image with each file in the base image to determine differences; and
storing the determined differences in the differential backing object resulting in an entire file in the local image being stored in the differential backing object if there is no version of the file in the base image.

15. The method of claim 13, wherein generating the differential backing objects further comprises:
generating a checksum for each file in the local image;
storing each generated checksum in the differential backing object.

16. The method of claim 13, further comprising:
receiving a restore request from one of the clients to restore the local image of the client to a selected state indicated in one of the differential backing objects;
determining the differential backing object representing the selected state of the requesting client;
determining each file in the current local image that comprises a modified version of one file indicated in the determined differential backing object; and
for each determined file in the current local image, applying differences for the file in the determined differential backing object to a version of the file in the base image to generate the file as of the selected state; and
writing the generated file as of the selected state to the client.

17. A system in communication with a plurality of clients, comprising:
a storage;
a processor;
code executed by the processor to cause operations to be performed, the operations comprising:
maintaining a base image in the storage comprising operating system files, configuration files, and device driver files installed on the clients;
generating differential backups for the clients indicating differences between local images on the clients following installation of the base image, wherein applying one of the differential backing objects to the base image forms one of the local images at one of the clients at a point-in-time of when the differential backing object was created; and
storing the differential backing objects from the clients in the storage.

18. The system of claim 17, wherein generating the differential backing objects for the local images on the clients further comprises:
comparing each file in the local image with each file in the base image to determine differences; and
storing the determined differences in the differential backing object resulting in an entire file in the local image being stored in the differential backing object if there is no version of the file in the base image.

19. The system of claim 17, wherein generating the differential backing objects further comprises:
generating a checksum for each file in the local image;
storing each generated checksum in the differential backing object.

20. The system of claim 17, further comprising:
receiving a restore request from one of the clients to restore the local image of the client to a selected state indicated in one of the differential backing objects;
determining the differential backing object representing the selected state of the requesting client;
determining each file in the current local image that comprises a modified version of one file indicated in the determined differential backing object; and
for each determined file in the current local image, applying differences for the file in the determined differential backing object to a version of the file in the base image to generate the file as of the selected state; and
writing the generated file as of the selected state to the client.
